(19) United States
(12) Patent Application Publication
(10) Pub. No.: US 2007/0241573 A1
(43) Pub. Date: Oct. 18, 2007

(54) Power operated pick-up tool

(76) Inventor: Li-Yu Teng, Taipei (TW)

Correspondence Address: BACON & THOMAS, PLLC, 625 SLATERS LANE, FOURTH FLOOR, ALEXANDRIA, VA, 22314, US

(21) Appl. No.: 11/402,916

(22) Filed: Apr. 13, 2006

(51) Int. Cl. B25J 1/00

(52) U.S. Cl. 294/19.1

(57) ABSTRACT

A power operated pick-up tool comprises a hollow handle and a battery operated motor received in the handle for imparting a rotary motion driving force through an output gear, a gear reduction assembly reducing the speed of the rotation of the output gear before transmitting the rotational force to a nut and screw assembly which converts the rotational motion into a linear motion of the nut, an elongate hollow stalk having a distal end and a proximal end attached to the handle, and a clamping assembly attached to the distal end of the stalk and the nut of the nut and screw assembly such that the clamping assembly can be operated to grasp an object or release a grasped object upon actuation of the motor.

### FIELD OF THE INVENTION

This invention relates to a pick-up tool for reaching and fetching objects, particularly, to a pick-up tool which is driven by electricity.

### BACKGROUND OF THE INVENTION

Single-hand actuated pick-up tools are known to reach and fetch objects. FIG. 6 shows a conventional pick-up tool, which comprises an elongate hollow stalk 501 having a distal end 502 and a proximal end 503. Each of two outer flexible, spring fingers 504 is attached at its proximal end to the outside of the stalk 501 and is attached at its distal end to a flexible clamping cup 505. Each of two inner flexible spring fingers 506 extends from the flexible clamping cup 505 through the interior of the stalk 501 to a trigger 507 which is pivotally mounted at the proximal end 503 of the stalk 501 and used to pull the two inner flexible spring fingers 506 backward (toward the trigger) when squeezed by a user. The backward pull of the two inner flexible spring fingers 506 will cause the two flexible clamping cups 505 to come together in order to grasp an object through the flexing and bending of the two outer flexible, spring fingers 504 toward each other.

When operating this kind of conventional pick-up tool, a user must use his/her hand to squeeze the trigger in order to grasp an object. However, such an operation is laborious, especially for weak or older people and children. Hence, it needs an improved pick-up tool which is labor-saving.

### SUMMARY OF THE INVENTION

The main object of this invention is to provide a pick-up tool, which is electricity driven and thus is labor-saving for users.

The present invention provides an electric powered pick-up tool comprising a hollow handle and a power means received in the handle for imparting a rotary motion driving force and having an output gear. A gear reduction assembly reduces the speed of the rotation of the output gear before transmitting the rotational force to a nut and screw assembly which converts the rotational motion into a linear motion of the nut. An elongate hollow stalk has a distal end and a proximal end attached to the handle. A pair of outer flexible, spring fingers are attached at the distal end of the stalk and have clamping elements terminating at the outer ends of the fingers for grasping an object when brought toward one another. A pair of inner flexible spring fingers extend from the clamping elements through the interior of the stalk and operably connect with the nut and screw assembly such that the pair of inner flexible spring fingers can be pulled toward the handle to bring the clamping elements toward one another or pushed toward the clamping elements to bring the clamping elements away from one another. Preferably, the power means is a battery operated motor.

When operating the pick-up tool of the invention, users can just press a switch on the handle at a first position to actuate the power means to cause the two flexible clamping elements to come together for grasping an object. On the contrary, when users press the switch at a second position to actuate the power means, the two flexible clamping elements will move away from each other to release the object.

The structure and advantage of the invention will become more apparent by reading the following description of the preferred embodiment with the accompanying drawings.

### BRIEF DESCRIPTION OF THE DRAWINGS

FIG. 1 is a perspective view of a preferred embodiment of a pick-up tool in accordance with the present invention;

FIG. 2 is an exploded perspective view of the pick-up tool of FIG. 1;

FIG. 2A is an enlarged drawing showing the bearing, gear box, copper sleeve, linkage rod, travel limit stop and stalk shown in FIG. 2, wherein the gear box, copper sleeve and linkage rod are shown in section;

FIG. 3 is a longitudinal sectional view showing the pick-up tool of FIG. 1 in a gripping condition;

FIG. 4 is a longitudinal sectional view showing the pick-up tool of FIG. 1 in a non-grasping condition;

FIG. 4A is an enlarged view showing a portion circled by dash line W in FIG. 4;

FIG. 5 is a schematic view showing the circuit formed by the contact switch, battery set, two travel limit switches and motor; and

FIG. 6 is a perspective view of a conventional pick-up tool.

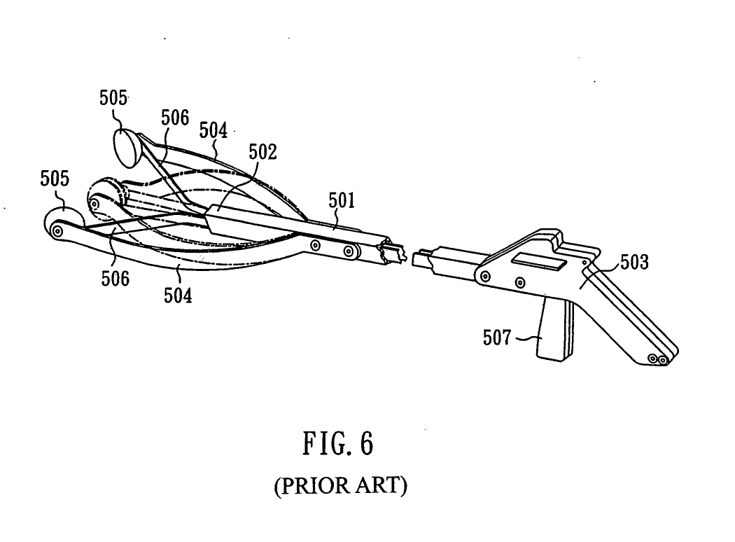

### DESCRIPTION OF THE PREFERRED EMBODIMENT

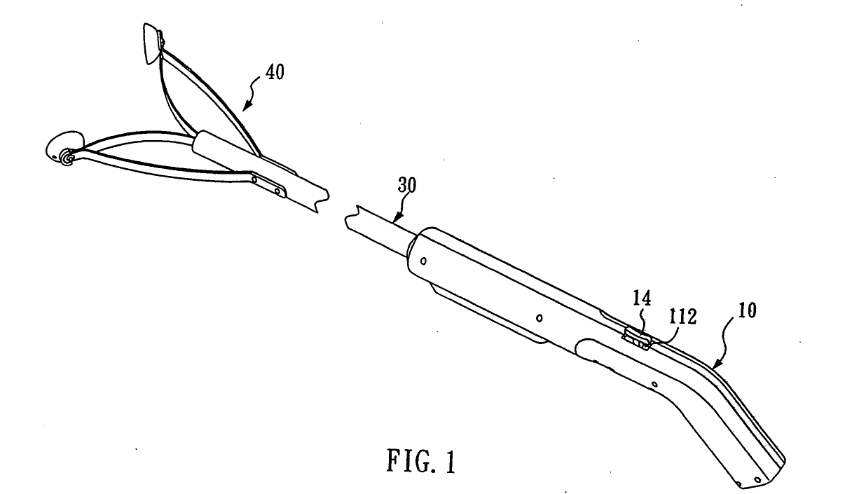

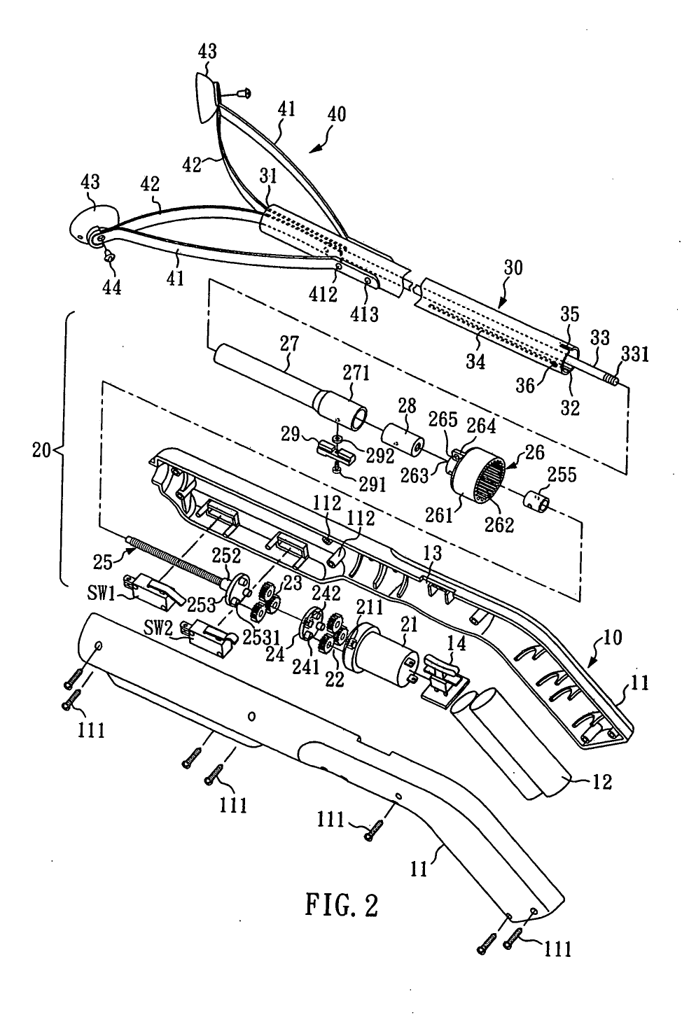

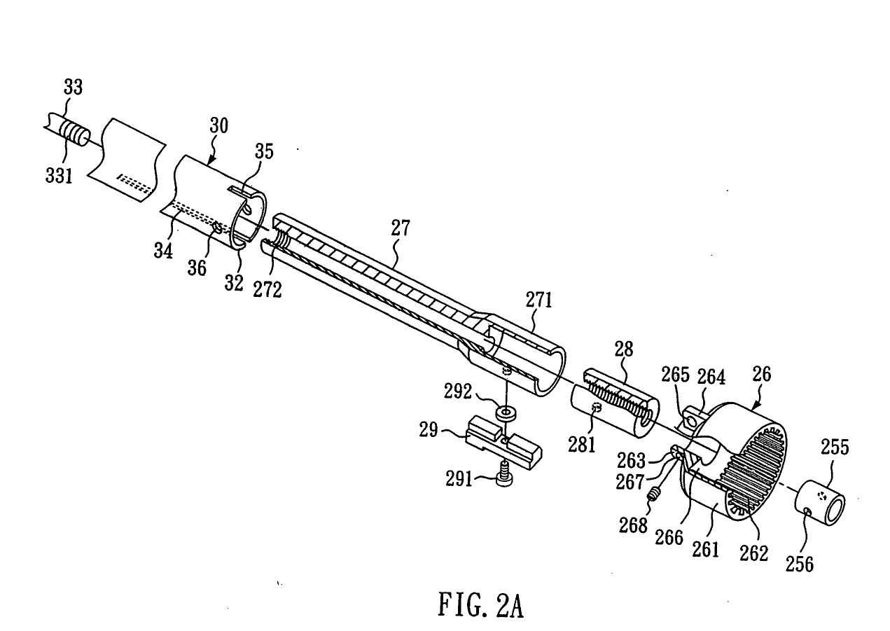

Referring to FIGS. 1 and 2, the pick-up tool of the present invention comprises a hollow handle 10, an elongate hollow stalk 30 and a clamping assembly 40. A battery set 12, an electric motor 21 having an output gear 211, and a transmission assembly 20 are provided within the handle 10.

Referring to FIG. 2, the hollow handle 10 is formed of two housing halves 11 connected together through screws 111. The upper side of the handle 10 has an opening 13 for receiving a switch 14, such as a contact switch, which is electrically connected to the battery set 12 and the motor 21, although the wiring is not shown for clarity.

The elongate hollow stalk 30 has a distal end 31 and a proximal end 32, and receives a wire rod 33 therein. A proximal end of the wire rod 33 has threads 331. At the proximal end 32, the stalk 30 has a cut 35 provided at the upper side thereof and an elongate slot 34 extending along the bottom side thereof, opposite to the cut 35. The slot 34 has an appropriate length depending on demands. The cut 35 and the elongate slot 34 all extend to the proximal end of the stalk 30.

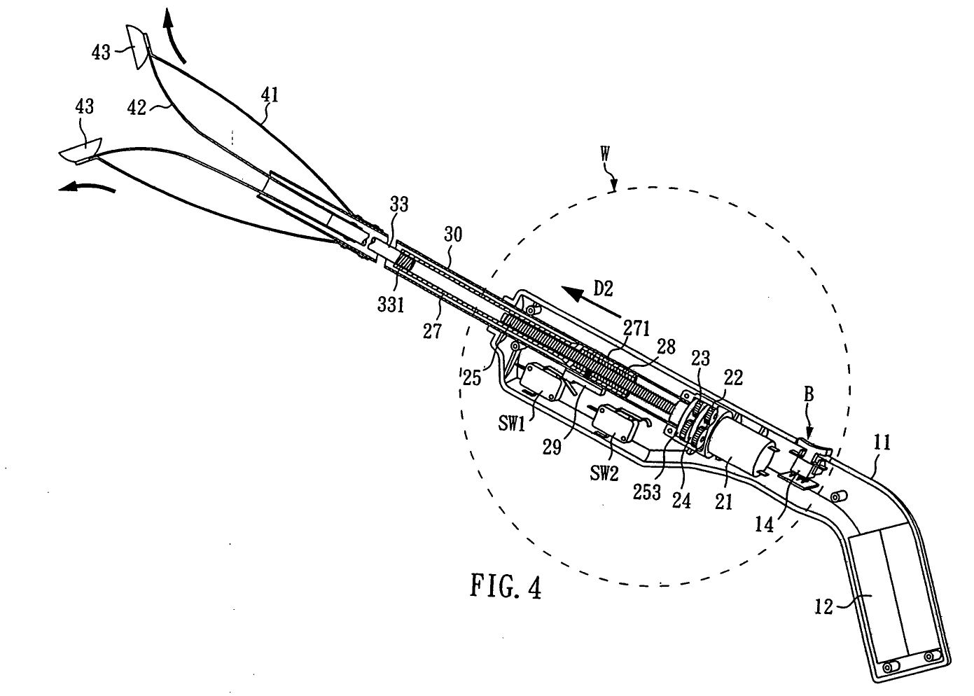

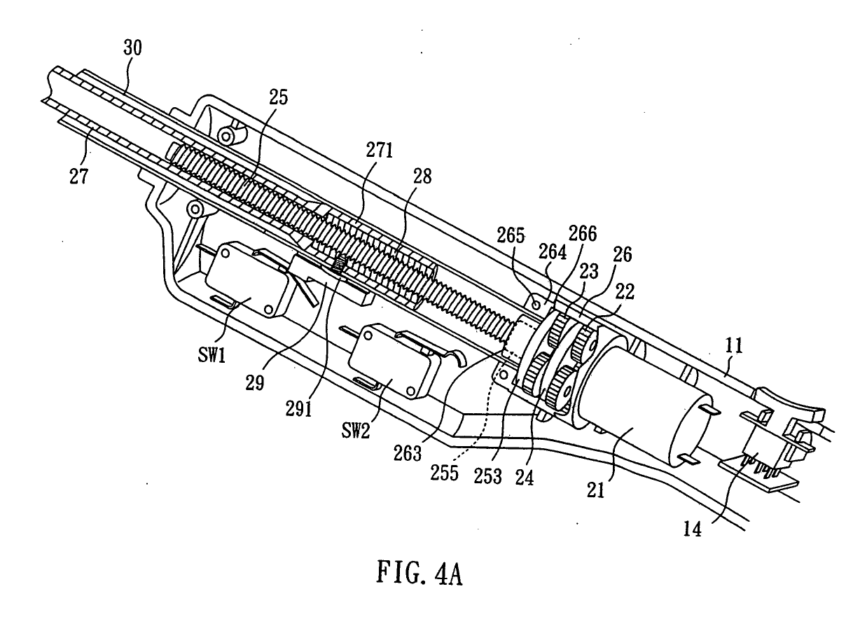

Referring to FIGS. 2 and 4A, the transmission assembly 20 comprises a first set and a second set of planet gears (22, 23) mounted on gear stands 24 and 253, respectively, and a cylindrical gear case 26.

The gear stand 24 has three radially equally located studs 241 provided at one side thereof. Each stud 241 is used for mounting thereon each planet gear of the first set of planet gears 22. The first set of planet gears 22 engage both the output gear 211 of the motor 21 as a sun gear as well as an internal gear 262 of the cylindrical gear case 26. A sun gear 242 is provided in the center of another side of the gear stand 24 for engaging with the second set of planet gears 23 which mounted on three studs 2531 radially equally located on the gear stand 253. The second set of planet gears 23 also engage with the internal gear 262 of the cylindrical gear case 26.

Since the detailed structure and function of the sun and planet gear are well known to a person skilled in the art, the description therefore is omitted here.

As shown in FIGS. 2A and 4A, the cylindrical gear case 26 has a larger diameter portion 261 of which the interior surface forms the internal gear 262 as a ring gear, and a smaller diameter tube portion 263 forming an annual shoulder 266 at the bottom of the larger diameter portion 261. The larger diameter portion 261 and the smaller diameter portion 263 have the same central axis.

The smaller diameter portion 263 has two diametrically positioned lugs 264 each having a through hole 265 and provided at the outside thereof for engaging with the cuts 35 and the slot 34 of the stalk 30, respectively, so as to mount the gear case 26 onto the proximal end 32 of said stalk 30 and also secure the gear case 26 to the inner side wall of one of the housing halves 11 via screws (not shown) extending through the holes 265 and into the receiving holes 112 on the inner side wall of the one of the housing halves 11 (FIG. 2). A bearing or a bushing 255 is fitted in the smaller diameter tube portion 263. The stalk 30, with its proximal end 32 fitted on the smaller diameter tube portion 263, and bearing 255 are fixed together via a set screw 268 threaded through holes (36, 267, 256) provided at the proximal end 32, smaller diameter tube portion 263 and bearing 250, respectively.

Referring to FIGS. 2, 2A and 4A, the transmission assembly 20 further includes a screw 25 having an enlarged end 252 connected to the gear stand 253. A hollow linkage rod 27 in the stalk 30 has an enlarged end portion 271 for receiving therein a nut 28, preferably made of copper, which engages with the screw 25.

A stop 29 is fixed at the bottom of the enlarged end portion 271 via a screw 291 extending through the stop 29, a washer 292 and the end portion 271. The screw 291 is also used to fix the nut 28 in the end portion 271 by extending through a recess 281 in the nut 28.

A smaller end of the hollow linkage rod 27 has internal threads 272 for engaging with the threads 331 on one end of the wire rod 33.

As shown in FIG. 4A, the screw 25 is inserted through the gear case 26 with the gear stand 253 abutting against the shoulder 266 of the larger diameter portion 261 of the gear case 26 and the enlarged end 252 rotatably supported in the bearing 255, and engages with the nut 28 fixed in the linkage rod 27. The rod 27 is received in the stalk 30 with the stop 29 projecting through the slot 34 of the stalk 30 and outside of the stalk 30.

First and second travel limit switches (SW1, SW2) are provided on the inner surface of said handle 10 near the distal end of the handle 10 and beneath the elongate slot 34 of the stalk 30 and the stop 29. The first and the second travel switches (SW1, SW2) are spaced apart at an appropriate distance depending on the maximum travel of the stop 29.

The clamping assembly 40 is attached to the distal end 31 of the stalk 30, and has two outer flexible, spring fingers 41 each attached at its proximal end via rivets 413 to the outside of the stalk 30 and is attached at its distal end to a flexible clamping cup 43 via post and nut combination 44, and two inner flexible spring fingers 42 each extending from the flexible clamping cup 43 through the interior of the stalk 30 and connected with the distal end of the wire rod 33 via rivets (not shown in the drawings).

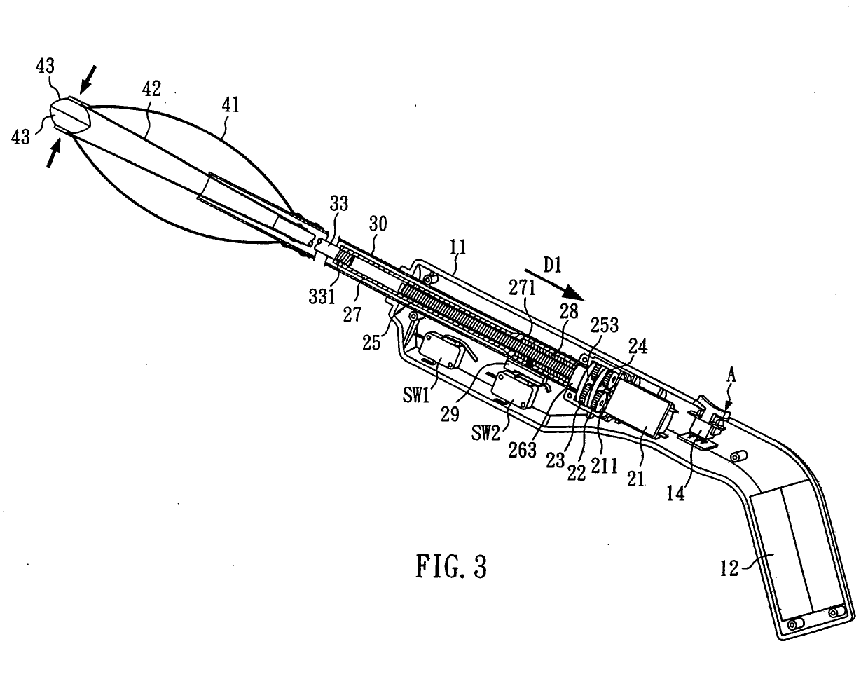

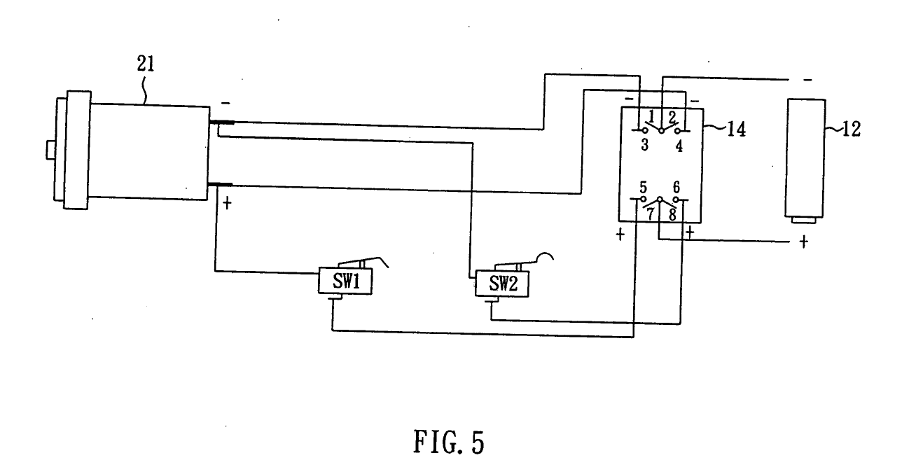

Referring to FIGS. 3 and 5, when a user wants to grasp an object, he/she can press the contact switch 14 in a first position A. At this time, in the contact switch 14, contact 2 connects with contact 4, and contact 8 connects with contact 6 such that a closed circuit is formed between the motor 21, the travel limit switch SW2, contact switch 14 and battery set 12, and the motor 21 is rotated in a counterclockwise direction (as observed from the handle toward the clamping cup) and the sun gear 211 of the motor 21 is thus rotated in a counterclockwise direction. The first set of planet gears 22 engaging with the sun gear 211 and the ring gear 262 are rotated in a clockwise direction to cause the rotation of the gear stand 24 and the sun gear 242 in a counterclockwise direction. Further, with the sun gear 242 engaging with the second set of planet gears 23 which engage with the ring gear 262, the planet gears 23 are rotated in a clockwise direction to cause the rotation of the screw 25 in a counterclockwise direction such that the nut 28 together with linkage rod 27 and the wire rod 33 can be pulled backward as shown in arrow D1. The backward pull of the wire rod 33 also causes the rearward pull of the inner spring fingers 42 such that the two clamping cups 43 can come together for grasping an object by flexing and bending the outer flexible spring fingers 41. It can be appreciated that the enlarged end portion 271 of the rod 27, slidably fitted in the stalk 30, serves a guide for the sliding movement of the rod 27 along the stalk 30.

During the rearward movement of the linkage rod 27, the stop 29 attached to the linkage rod 27 will also be moved backward. When the stop 29 touches the second travel limit switch SW2, the second travel switch SW2 will be switched off. At this time, the flexible clamping cups 43 are at their maximum clamping force. Of course, during the rearward movement of the inner flexible spring fingers 42, the wire rod 33 and the linkage rod 27 to make the flexible clamping cups 43 come together, the user can release the contact switch 14 any time to switch off the circuit depending on demands.

Referring to FIGS. 4, 4A and 5, after the flexible clamping cups 43 have grasped the object, the user can press the contact switch 14 in a second position B in order to make the flexible clamping cups 43 move apart from each other to release the object. When the user presses the contact switch 14 in the second position B, contact 1 connects with contact 3, and contact 7 connects with contact 5 such that a closed circuit is formed between the motor 21, the travel limit switch SW1, contact switch 14 and battery set 12. At this time, the motor 21 is rotated in a clockwise direction (as seen from the handle toward to the clamping cups) and the sun gear 211 of the motor 21 is thus rotated in a clockwise direction. Since the first set of planet gears 22 engages with the sun gear 211, the planet gears 22 are rotated in a counterclockwise direction to cause the rotation of the gear stand 24 and the sun gear 242 in a clockwise direction. Further, since the sun gear 242 engages with the second set of planet gears 23, the planet gears 23 are rotated in a counterclockwise direction to cause the rotation of the screw 25 rotated in a clockwise direction such that the linkage rod 27 with the wire rod 33 can be pushed forward as shown in arrow D2. The forward push of the wire rod 33 also causes the forward push of the inner flexible spring fingers 42 such that the flexible clamping cups 43 can move apart from each other for releasing the object.

During the forward movement of the inner flexible spring fingers 42, the wire rod 33 and the linkage rod 27, the stop 29 will also be moved forward. When the stop 29 touch the first travel limit switch SW1, the first travel limit switch SW1 will be switched off. At this time, the flexible clamping cups 43 are at their maximum opening position.

In the embodiment of the invention, the numbers of the teeth of the sun gears (211, 242), planet gears (22, 23) and the ring gear 262 are 12, 15 and 42, respectively. Thus the ratio between the rotational speed of the motor and the screw is about 20.27:1. Therefore, if the rotational speed of the motor 21 is 18000 rpm, then the rotational speed of the screw 25 would be 888 rpm. The sun and planet gear can reduce the speed of the output rotation of the motor while increase the torque to perform the grasping action of the flexible clamping assembly 40. The distance between the first and the second travel limit switches (SW1, SW2) can determine the closing and opening range of the two flexible clamping cups 43.

The preferred embodiment described herein is depicted in order to provide an example of the present invention, and not limiting of the scope of the invention. Other embodiments and variations will be apparent to those skilled in the art and may be made without departing from the essence and scope of the invention as defined in the attached claims.

What is claimed is:

1. A power operated pick-up tool, comprising:
a hollow handle;
a power means for imparting a rotary motion driving force;
a transmission assembly operably associated with said power means;
an elongate hollow stalk having a distal end and a proximal end attached to said handle;
a pair of outer flexible, spring fingers attached at said distal end of said stalk and having clamping elements terminating at the outer ends of said fingers for grasping an object when brought toward one another;
a pair of inner flexible spring fingers extending from said clamping elements through the interior of said stalk and operably associated with said transmission assembly such that said transmission assembly can be operated to draw said pair of inner flexible spring fingers toward said handle to bring said clamping elements toward one another or push said pair of inner flexible spring fingers toward said clamping elements to bring said clamping elements away from one another.

2. The pick-up tool of claim 1 wherein said transmission assembly and said power means are received in said hollow handle, and wherein said transmission assembly includes a gear reduction assembly associated with said power means.

3. The pick-up tool of claim 2 wherein said transmission assembly includes a converting means associated with said gear reduction assembly for converting said rotary motion driving force into a linear motion of said pair of inner flexible spring fingers.

4. The pick-up tool of claim 3 wherein said converting means comprises a nut and screw assembly including:
a linkage rod received in said stalk and having a proximal end and a distal end operably connected with said pair of inner flexible spring fingers;
a nut provided at said proximal end of said linkage rod; and
a screw extending through said linkage rod and engaging with said nut.

5. The pick-up tool of claim 2 wherein said gear reduction assembly comprises a sun and planet gear.

6. The pick-up tool of claim 4, further comprising:
a travel limit block attached to said linkage rod; and
two travel limit switches provided in said handle and spaced apart at a predetermined distance for contacting said travel limit block, respectively, to limit the travel of said linkage rod.

7. The pick-up tool of claim 1 wherein said power means comprises a battery operated motor.

8. An electric powered pick-up tool, comprising:
a hollow handle;
an electric motor received in said handle for imparting a rotary motion driving force and having an output gear;
a gear reduction assembly associated with said motor;
a nut and screw assembly including a nut and a screw engaging with said nut and associated with said gear reduction assembly for converting said rotary motion driving force into a linear motion of said nut, said nut being a part of a linkage rod through which said screw extends;
an elongate hollow stalk having a distal end and a proximal end attached to said handle;
a pair of outer flexible, spring fingers attached at said distal end of said stalk and having clamping elements terminating the outer ends of said fingers for grasping an object when brought toward one another;
a pair of inner flexible spring fingers extending from said clamping elements through the interior of said stalk and operably connected with said linkage rod of said nut and screw assembly such that said pair of inner flexible spring fingers can be pulled toward said handle to bring said clamping elements toward one another or pushed toward said clamping elements to bring said clamping elements away from one another.

9. The pick-up tool of claim 8 wherein said gear reduction assembly comprises a sun and planet gear.

10. The pick-up tool of claim 9, further comprising:
a slot extending at least a part of the length of said stalk;
a travel limit block attached to said linkage rod and projecting through said slot of said stalk; and
two travel limit switches provided in said handle and spaced apart at a predetermined distance for contacting said travel limit block, respectively, to limit the travel of said linkage rod.
